(19) United States
(12) Patent Application Publication
(10) Pub. No.: US 2010/0072162 A1
(43) Pub. Date: Mar. 25, 2010

(54) BABY BOTTLE

(75) Inventor: Yong Jick Park, Seoul (KR)

Correspondence Address: CHRISTOPHER PAUL MITCHELL, 888 16TH ST., NW, SUITE 800, WASHINGTON, DC, 20006, US

(73) Assignees: Yong Jick PARK, Seoul (KR); AGA-BANG & COMPANY, Seoul (KR)

(21) Appl. No.: 12/595,511

(22) PCT Filed: Apr. 8, 2008
(86) PCT No.: PCT/KR08/01991

§ 371 Date: Oct. 10, 2009

(30) Foreign Application Priority Data
Apr. 10, 2007 (KR) 10-2007-0034878
Mar. 4, 2008 (KR) 10-2008-0019913

(51) Int. Cl. A61J 9/04; A61J 9/08

(52) U.S. Cl. 215/11.5; 215/11.6

(57) ABSTRACT

A baby bottle for preventing the release of endocrine disrupters is disclosed. The baby bottle includes a glass vessel containing milk. A protective cover has shock absorbing members to protect the glass vessel, and includes left and right cover bodies having a fastening protrusion and a fastening hole, respectively. An air inlet packing is placed on the upper end of the glass vessel to control inflow of external air, and is coupled to a ventilation tube and a nipple. A support cap is fastened to the upper end of the protective cover in such a way that the nipple is in close contact with the upper portion of the air inlet packing, when the air inlet packing is in close contact with the glass vessel. Thus, the baby bottle protects a baby from endocrine disrupters, and prevents air from flowing backwards during feeding, thus preventing the baby from spitting

### TECHNICAL FIELD

The present invention relates to a baby bottle, which is constructed so that a vessel containing milk is made of a glass material, and a protective cover is coupled to the outer surface of the vessel to protect the glass vessel, thus protecting babies from endocrine disruptors, and in which an air vent is formed in the vessel, thus preventing air from flowing backwards during feeding.

### BACKGROUND ART

A conventional baby bottle comprises a heat-resistant plastic vessel, so that it has high elasticity and elastic supporting force. Thus, even if the baby bottle is dropped, the baby bottle does not break. Generally, when a person desires to feed a baby, powdered milk and water are put into the plastic vessel, and are shaken and thus mixed with each other. In the case of cold milk, the milk is heated using a microwave oven or the like so as to feed a baby.

Recently, as the standard of living rises, people have interest in health, and mothers' concerns about baby products have increased. Among the baby products, a baby bottle is made of plastic, and thus endocrine disruptors are released when the baby bottle is heated. This causes anxiety to mothers. However, until now, a baby bottle which carries no danger of endocrine disruptors has not been developed.

In order to solve the problem, Korean U.M. Laid-Open Publication No. 2000-14155, which was filed previously, discloses a combination of a glass baby bottle and a protecting vessel.

The combination includes the protecting vessel, the glass baby bottle, and a nipple part. The protecting vessel is made of transparent or semitransparent plastic, and includes an upper vessel part and a lower vessel part which are assembled with each other, thus providing one vessel which is open at the top. The glass baby bottle is inserted into the protecting vessel to be accommodated therein, and is made of transparent glass which has high chemical durability, and has the shape of a vessel which is open at the top. The nipple part is coupled to the upper portion of the glass baby bottle in such a way as to be in close contact with the inner surface of the glass baby bottle.

Further, an air inlet tube is coupled to the nipple part.

The combination is advantageous in that the glass baby bottle is resistant to shocks, so that it does not easily break, and broken pieces of glass are not scattered to the outside when the glass baby bottle breaks, thus allowing the glass baby bottle to be safely used. However, the combination is problematic in that the baby bottle made of glass is in close contact with the protecting vessel which is provided outside the baby bottle, so that the combination is broken by shocks when the combination is dropped.

That is, the glass baby bottle is hermetically accommodated in the protecting vessel which is made of synthetic resin, thus preventing broken pieces of glass from being scattered when the glass baby bottle breaks. However, when a baby ingests milk by itself, the baby may throw or drop the baby bottle. In this case, the baby bottle breaks due to shocks. Thus, a user must frequently replace the baby bottle with a new one, which is uneconomical. Of course, this problem does not occur in the case where the mother holds the baby bottle to feed a baby.

Further, when milk is put into the baby bottle, the milk flows into the air inlet tube which is positioned in the baby bottle, and prevents air from flowing through the air inlet tube during feeding, thus leading to the backward flow of air. Hence, a baby ingests both the air and the milk, so that the baby may spit after feeding.

### DISCLOSURE OF INVENTION

### Technical Problem

Accordingly, the present invention has been made keeping in mind the above problems occurring in the prior art, and an object of the present invention is to provide a baby bottle, in which a vessel containing milk is made of a glass material, and a protective cover is coupled to the outer surface of the vessel so as to protect the glass vessel, thus protecting a baby from endocrine disruptors, and in which an air outlet port serving as a valve is provided on an end of a ventilation tube positioned in the baby bottle so as to prevent the inflow of milk, thus preventing air from flowing backwards during feeding, therefore preventing a baby from taking in both air and milk, and in which an air vent is formed in the baby bottle, thus preventing a baby from spitting or suffering from colic after feeding, due to the aeration of milk caused by the backward flow of air during feeding, and in which the ventilation tube is made of an elastic material to have an integrated structure and functions to stir milk when powdered milk is added to water in the vessel, and an elliptical reinforcing rib is provided on an end of the ventilation tube, thus preventing an air outlet port from being opened due to the motion of the water when the powdered milk is mixed with the water, and allowing the valve to maintain its original shape.

### Technical Solution

In order to accomplish the above object, the present invention provides a baby bottle, including a glass vessel which contains milk therein; a protective cover which protects the glass vessel and includes left and right cover bodies which are provided with one selected from among a fastening protrusion and a fastening hole and a remaining one thereof, respectively; an air inlet packing which is placed on the upper end of the glass vessel to control inflow of external air during feeding and is coupled to a ventilation tube and a nipple; and a support cap which is fastened to the upper end of the protective cover in such a way that the nipple is in close contact with the upper portion of the air inlet packing, when the air inlet packing is in close contact with the glass vessel.

Further, the baby bottle is provided with a base unit which corresponds to the bottom of the glass vessel and is coupled to the lower end of the protective cover that includes left and right cover bodies having shock absorbing members to mitigate shocks which are applied to the glass vessel.

The base unit includes a middle base plate which is provided on a lower end of either of the left and right cover bodies and has a coupling hole, and a cushioning plate which is placed on the middle base plate to be coupled to the coupling hole of the middle base plate.

Further, the glass vessel of the baby bottle according to the present invention includes the ventilation tube which is coupled to a coupling tube of the air inlet packing and is made of an elastic material, with a valve provided on an end of the ventilation tube so as to prevent milk from flowing into an air outlet port.

### ADVANTAGEOUS EFFECTS

According to the present invention, a baby bottle is constructed to have a glass vessel, a protective cover, and a ventilation tube, thus preventing the ventilation tube from being clogged with milk during feeding, therefore preventing air from flowing backwards. In proportion to the suction force of a baby who ingests the milk, external air is fed from the lower portion of the baby bottle through the ventilation tube, thus allowing the milk to be sucked with a predetermined pressure. Further, when the baby ingests the milk, air is not sucked, thus preventing the baby from suffering from colic or inflammation of the middle ear. The baby bottle prevents the application of excessive force to the mouth, thus preventing the shape of the mouth from be deformed according to the habit of sucking a nipple during feeding. The ventilation tube, positioned in the baby bottle, is made of an elastic material to thus have an integrated structure, so that it is unnecessary to hold the ventilation tube, which is to be immersed in milk, by the hand in order to install the ventilation tube in the vessel, thus being sanitary, and functions to stir milk, thus allowing powdered milk to be easily mixed with water. Further, an elliptical reinforcing rib is provided on an end of the ventilation tube, thus preventing an air outlet port from being opened due to the motion of the water when the powdered milk is mixed with the water, and allowing the valve to maintain its original shape. Further, the baby bottle is made of a glass material, so that endocrine disruptors are not released by the heat of warm milk, unlike a plastic material, thus providing healthy milk to a baby.

### BRIEF DESCRIPTION OF THE DRAWINGS

FIG. 1 is a perspective view showing the state in which a protective cover and a glass vessel of a baby bottle according to the present invention are coupled to each other;

FIG. 2 is an exploded perspective view showing the baby bottle according to the present invention, in which the protective cover is separated from the glass vessel;

FIG. 3 is a partial enlarged sectional view showing the coupled state of the protective cover and the glass vessel of the baby bottle, according to the present invention;

FIG. 4 is a partial enlarged sectional view showing the use of the baby bottle, according to the present invention;

FIG. 5 is a bottom exploded perspective view showing a base unit of the protective cover, according to the present invention;

FIG. 6 is an exploded perspective view showing the base unit of the protective cover, according to the present invention;

FIG. 7 is a cross-sectional view showing the coupled state of the protective cover and the glass vessel of the baby bottle, according to the present invention,

FIG. 8 is a view illustrating the bottoms of left and right cover bodies and the upper surface of a lower base plate, according to the present invention;

FIG. 9 is a view illustrating the construction of the lower portion of the protective cover, according to the present invention;

FIG. 10 is a view illustrating the closed and open states of an air inlet port which is formed in a baby bottle, according to another embodiment of the present invention;

FIGS. 11 and 12 are a perspective view and an exploded perspective view, respectively, showing a baby bottle, according to another embodiment of the present invention;

FIG. 13 is a view showing the construction of the lower portion of a protective cover, according to a further embodiment of the present invention;

FIGS. 14 and 15 are a perspective view and a sectional view, respectively, showing a ventilation tube, according to another embodiment of the present invention;

FIG. 16 is a sectional view showing the ventilation tube, according to the another embodiment of the present invention;

FIGS. 17 and 18 are a sectional view and a plan view, respectively, showing a ventilation tube, according to a further embodiment of the present invention; and

FIGS. 19 and 20 are views showing the state in which a valve control member of FIG. 18 is moved up and down.

### BEST MODE FOR CARRYING OUT THE INVENTION

Hereinafter, the embodiments of the present invention will be described.

According to the present invention, a baby bottle 1 includes a glass vessel 2, a protective cover 10, an air inlet packing 20, and a support cap 4. The protective cover 10 covers the outer surface of the glass vessel 2 to protect it. The air inlet packing 20 is provided on the upper end of the glass vessel 2, and controls the inflow of air during feeding, with a ventilation tube 21 and a nipple 3 connected to the air inlet packing 20. In the state where the air inlet packing 20 is in close contact with the glass vessel, the support cap 4 is coupled to the upper end of the protective cover 10 in such a way that the nipple 3 is in close contact with the upper portion of the glass vessel.

The protective cover 10 for protecting the glass vessel 2 includes left and right cover bodies 11 and 12, having fastening protrusions 13 and fastening holes 14 which are provided to face each other.

Further, shock absorbing members 50 are installed in the upper and lower portions of the protective cover 10, and mitigate shocks which are applied to the glass vessel 2. A middle base plate 36 is integrally provided on the lower end of at least one of the left and right cover bodies 11 and 12, which constitute the protective cover 10.

Fastening parts 15 are provided on the upper portions of the left and right cover bodies 11 and 12, and are fastened to the support cap 4 through a screw-type fastening method.

A coupling hole 37 is provided in the middle base plate 36, and a cushioning plate 31 is coupled to the middle base plate 36 via the coupling hole 37.

Further, a fitting groove 43 and a support piece 44 are provided on the bottom of the left cover body 11, which constitutes the protective cover 10, and a plurality of locking projections 42 is provided on the bottom of the right cover body 12.

The cushioning plate 31, which has on the bottom thereof a plurality of connecting projections 32, is connected to a connection plate 33, which has in the upper portion thereof a plurality of connecting holes 34 and has on the lower portion thereof a coupling protrusion 35.

Further, the connection plate 33 is coupled to a lower base plate 40 so that a coupling protrusion 35, protruding downwards from the connection plate 33, passes through the coupling hole 37 and is inserted into a hole 39 which is formed in the center of the lower base plate 40. A fitting protrusion 38 and an elastic piece 41 are provided at a predetermined position on the upper surface of the lower base plate 40.

Here, the fitting protrusion 38, provided on the lower base plate 40, is fitted into the fitting groove 42 which is provided on the bottom of the left cover body 11. The elastic piece 41 is installed to the lower base plate 40 to correspond to the locking projections 42 which are provided on the bottom of the right cover body 12.

Further, a base unit 30, which is attached to the lower end of the protective cover 10, which protects the outer surface of the glass vessel 2, includes the cushioning plate 31, the connection plate 33, and the middle base plate, which are coupled to each other. The cushioning plate 31 is made of a cushioning material, such as rubber, silicone, or soft synthetic resin, and is in contact with the bottom of the glass vessel 2, thus mitigating shocks applied to the glass vessel 2.

The ventilation tube 21 of the air inlet packing is coupled to an air valve 24, which has on the lower end thereof an air inlet port 23. A ball 22 is inserted into the air valve 24.

Further, a backward-movement preventing protrusion 24′ is provided in the air valve 24 to prevent the backward movement of the ball 22.

Meanwhile, a different air valve 24a may be mounted to the lower portion of the ventilation tube 21. The air valve 24a is formed such that the upper portion thereof is wide and the lower portion thereof is narrow, and an air inlet port 23′ is in close contact with the lower end of the air valve 24a.

On the other hand, another different air valve 24 is provided on an end of the ventilation tube 21, and has an air outlet port 17 which prevents milk from entering the ventilation tube.

Here, the valve 24 includes the air outlet port 17, which is provided on the end of the ventilation tube 21 in such a way as to be positioned in the center of the bottom of the valve, and has a “-” shape. A plurality of reinforcing ribs 52 and grooves 51 is provided around the air outlet port.

Further, a “V”-shaped inclined surface 56, which is narrow at the lower end thereof and is wide at the upper end thereof, is provided in the air outlet port 17, so that external air can easily enter the glass vessel 2, but milk in the glass vessel 2 cannot easily enter the air outlet port 17.

Further, an air valve 24a, having a valve chamber 55 which has a larger diameter than the ventilation tube 21, may be mounted to the lower portion of the ventilation tube 21. A valve control member 53 is provided in the valve chamber 55, and a plurality of air inlet holes 54 is formed in the lower end of the valve chamber 55.

The present invention, constructed as described above, will be described in detail with reference to the accompanying drawings.

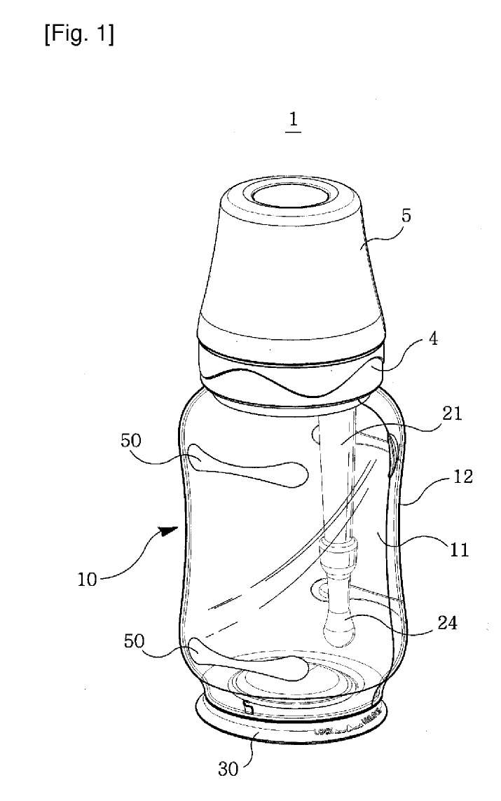

FIG. 1 is a perspective view showing the coupled state of the glass vessel and the protective cover of the baby bottle according to the present invention. The protective cover 10, including the left cover body 11 and the right cover body 12, is coupled to the outer surface of the glass vessel 2. The base unit 30 is secured to the lower end of the protective cover 10. When the support cap 4, equipped with the nipple 3, is fastened to the fastening parts 15, the support cap supports the glass vessel 2 positioned in the protective cover 10 and the air inlet packing 20, which is in close contact with the glass vessel.

At this time, the junctions of the left and right cover bodies 11 and 12, constituting the protective cover 10, are firmly fastened to each other using the fastening protrusions 13 and the fastening holes 14.

Further, the shock absorbing members 50, which are provided on the upper and lower portions of the left and right cover bodies 11 and 12, are provided to support the outer surface of the glass vessel 2, thus mitigating external shocks, therefore preventing the glass vessel 2 from breaking.

Each shock absorbing member 50 is made of a material which is capable of absorbing shocks, for example, silicone, soft synthetic resin, or rubber.

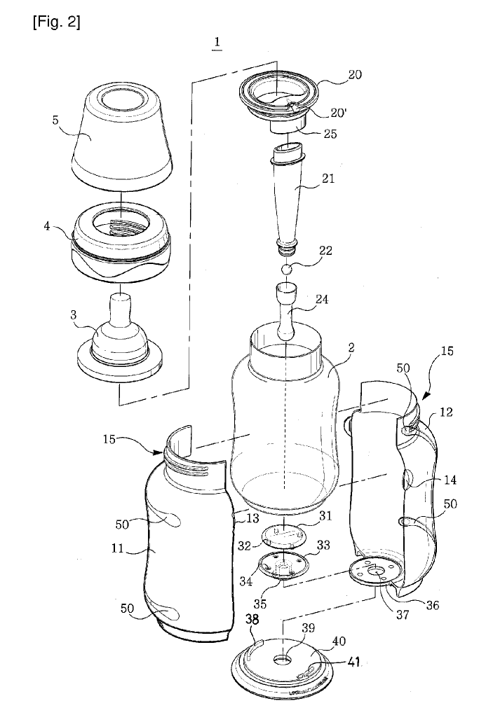

FIG. 2 is an exploded perspective view showing the baby bottle according to the present invention, in which the protective cover is separated from the glass vessel. The baby bottle 1 of the present invention is constructed to be easily assembled or disassembled, as necessary. When a user desires to separate the protective cover from the glass vessel, the support cap 4 having the nipple 3 is separated from the protective cover, and the base unit 30 is separated from the protective cover. In this state, the fastening holes 14, which are provided on the junctions of the left and right cover bodies 11 and 12, are pressed, so that the fastening protrusions 13 are removed from the fastening holes 14 due to the elasticity of the protective cover 10. Thereby, the left cover body 11 is removed from the glass vessel, and thus it is possible to wash the glass vessel.

Further, when the baby bottle 1 is used to feed a baby, the left and right cover bodies 11 and 12 are aligned with each other to cover the outer surface of the glass vessel 2, and the protective cover 10 is coupled to the glass vessel 2 using the fastening protrusions 13 and the fastening holes 14.

Further, when the base unit 30 is coupled to the protective cover 10, the middle base plate 36 forms the bottom of the right cover body 12, which is provided on one side of the protective cover 10. The cushioning plate 31 is coupled to the upper portion of the middle base plate 36 with the connecting projections 32 of the cushioning plate 31 fitted into the connecting holes 34 of the connection plate 33. The connection plate 33 is superposed on the middle base plate 36 by inserting the coupling protrusion 35 of the connection plate 33 into the coupling hole 37, which is formed in the center of the middle base plate 36.

The fitting protrusion 38, which is provided at a predetermined position on the upper protruding surface of the lower base plate 40 constituting the base unit 30, is fitted into the fitting groove 43, which is provided on the bottom of the left cover body 11, and the support piece 44 supports one end of the fitting protrusion, thus preventing the left cover body 11 from being opened outwards.

Here, one end of the fitting groove has the shape of a “̂!”, while the other end of the fitting groove has the shape of a “-”. One end of the fitting protrusion of the lower base plate is fitted into the “̂”-shaped end, thus preventing the left and right cover bodies from being opened when the protective cover is coupled to the base unit.

After the base unit 30 is coupled to the protective cover 10, the air inlet packing 20 connected with the ventilation tube 21 is placed on the upper ends of the glass vessel 2 and the protective cover 10. Subsequently, the support cap 4 equipped with the nipple 3 is fastened to the fastening parts 15 provided on the upper end of the protective cover 10,

At this time, water and powdered milk are put into the glass vessel 2 so as to be mixed with each other. The position of the ventilation tube 21 having the air valve 24 is adjusted by a coupling tube 25 such that the ventilation tube is positioned in the glass vessel 2 containing milk therein. In this state, it is possible to feed a baby using the baby bottle 1.

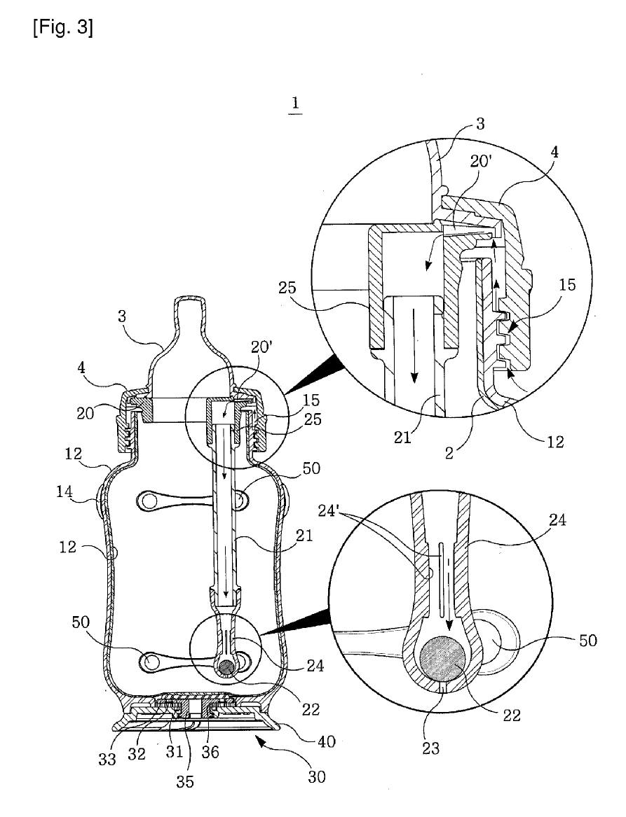

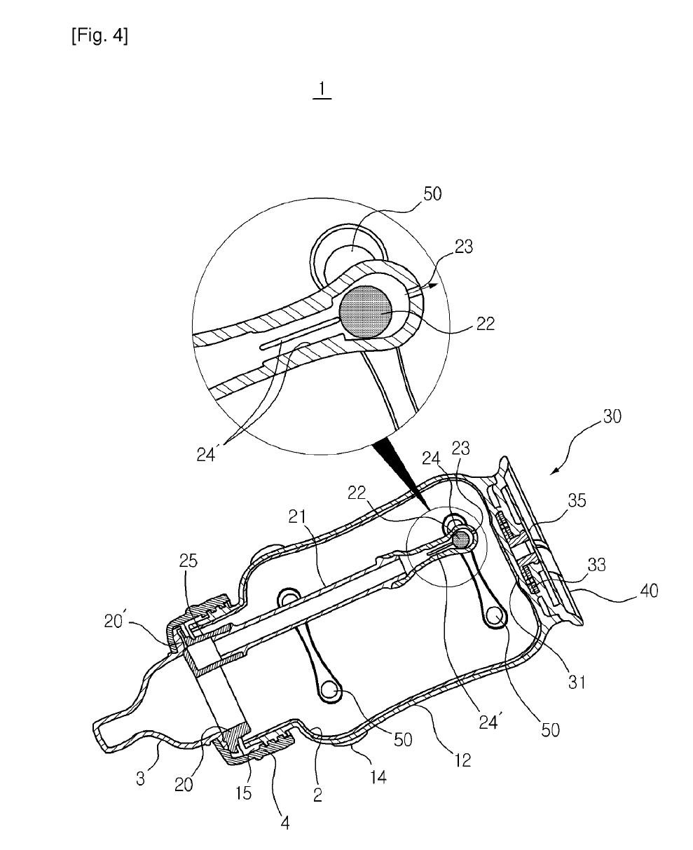

FIG. 3 is a partial enlarged sectional view showing the coupled state of the glass vessel and the protective cover of the baby bottle, according to the present invention, and FIG. 4 is a partial enlarged sectional view showing the use of the baby bottle according to the present invention. The protective cover 10 covers the glass vessel 2 to protect it, and the support cap 4 is fastened to the fastening parts 15, which are provided on the upper end of the protective cover 10, so that the nipple 3, the air inlet packing 20, and the protective cover 10 of the baby bottle 1 are coupled to the upper end of the glass vessel 2, and seals the interior of the glass vessel 2 so as to prevent milk from leaking out from the glass vessel 2.

Here, the ventilation tube 21, which is coupled to the lower end of the air inlet packing 20 and has the air valve 24, is coupled to the coupling tube 25, which extends downwards from the air inlet packing 20, and is disposed in the glass vessel 2.

Further, air can circulate between the fastening parts and the support cap 4 fastened to the fastening parts 15, which are provided on the upper end of the protective cover 10. Thus, the air is fed into an air inlet channel 20′, which is provided at a predetermined position in the air inlet packing 20, and is discharged through the ventilation tube 21 to the air inlet port 23 of the air valve 24. This construction allows a baby to ingest milk with a predetermined pressure.

Therefore, the baby bottle according to the present invention is provided with the ventilation tube which permits the inflow of air into the glass vessel 2 and controls the flow of air in order to prevent a vacuum from forming during feeding. The present invention prevents a baby from spitting or suffering from colic due to the backward flow of air when the baby sucks the nipple 3 to ingest milk. Further, the present invention prevents the baby from suffering from inflammation of the middle ear and prevents the baby's mouth from being deformed, unlike the conventional baby bottle, which has no vent and thus creates a vacuum in the baby bottle during feeding and increases the pressure with which a baby must ingest milk.

As shown in FIG. 4, when a baby feeds with the baby bottle 1 loaning to one side, the ball 22, which is positioned in the air valve 24 provided on the lower end of the ventilation tube 21, moves to one side, so that the air inlet port 23 is opened, and thus external air can enter the baby bottle 1. This construction enables smooth control of the pressure of ingested milk and the pressure with which a baby's mouth sucks milk during feeding.

Even if the baby bottle 1 is tilted, the ball 22 positioned in the air valve 24 is not removed from the ventilation tube 21 because of the backward-movement preventing protrusion 24′, which is provided in the air valve 24.

Further, since the ball 22 is made of an elastic silicone material, the air valve 24 is forcibly opened, and thereafter, the ball 22 is inserted into the air valve 24 to be disposed in the ventilation tube 21. Thus, it is easy to insert the ball into the air valve 24 in the assembly of the baby bottle.

When the baby bottle 1 is placed upright, the ball 22 moves to the lower end of the air valve 24, thus closing the air inlet port 23, therefore preventing milk remaining in the glass vessel 2 from spoiling due to the contact of the milk with external air.

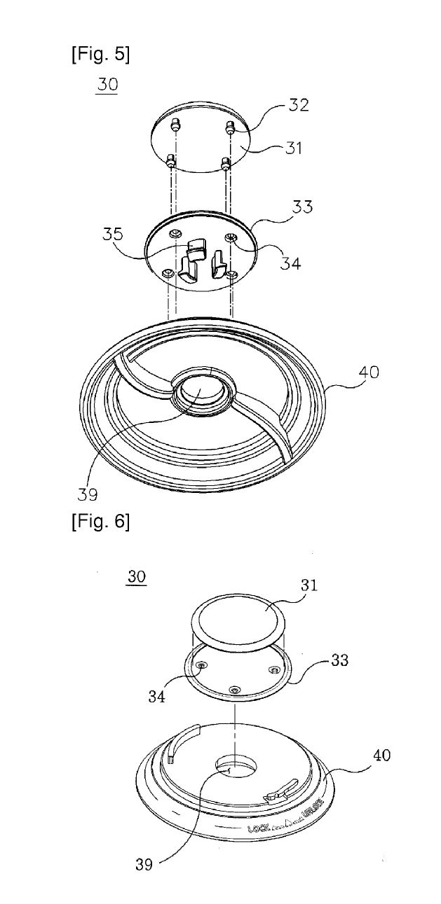

FIG. 5 is a bottom exploded perspective view showing the base unit of the protective cover, according to the present invention, and FIG. 6 is an exploded perspective view showing the base unit of the protective cover, according to the present invention. The base unit 30, which supports the bottom of the protective cover 10, which protects the outer surface of the glass vessel 2, includes the cushioning plate 31, the connection plate 33, and the lower base plate 40, which are coupled to each other.

Here, the cushioning plate 31 is made of a cushioning material, such as rubber, silicone, or soft synthetic resin, and is in contact with the bottom of the glass vessel 2, thus mitigating shocks applied to the glass vessel 2.

Further, the middle base plate 36 and the lower base plate 40 are placed to correspond to each other. In order to detachably couple the cushioning plate 31 to the connection plate 33, the plurality of connecting projections 32 is provided on the lower surface of the cushioning plate 31, and is fitted into the connecting holes 34 in the connection plate 33. Thereafter, the coupling protrusion 35 provided on the connection plate 33 is inserted into the coupling hole 37 in the middle base plate 36. In this case, the coupling protrusion 35 may be inserted into the hole 39 in the lower base plate 40.

As shown in FIG. 6, the lower base plate 40 has in the center thereof the hole 39. Thus, when the coupling protrusion 35 of the connection plate 33 is inserted into the hole, and the lower base plate is rotated to one side, the fitting protrusion 38, which is provided on one side of the upper surface of the lower base plate 40, is fitted into the fitting groove 43, which is provided on the bottom of the left cover body 11. The elastic piece 41, which is provided on the other side of the upper surface of the lower base plate 40, is supported by the plurality of locking projections, which are provided on the lower surface of the right cover body.

Here, one end of the elastic piece 41 is integrated with the lower base plate 40, while the other end of the elastic piece 41 is spaced apart from the upper surface of the lower base plate 40, so that the elastic piece 41 is in elastic contact with the locking projections 42.

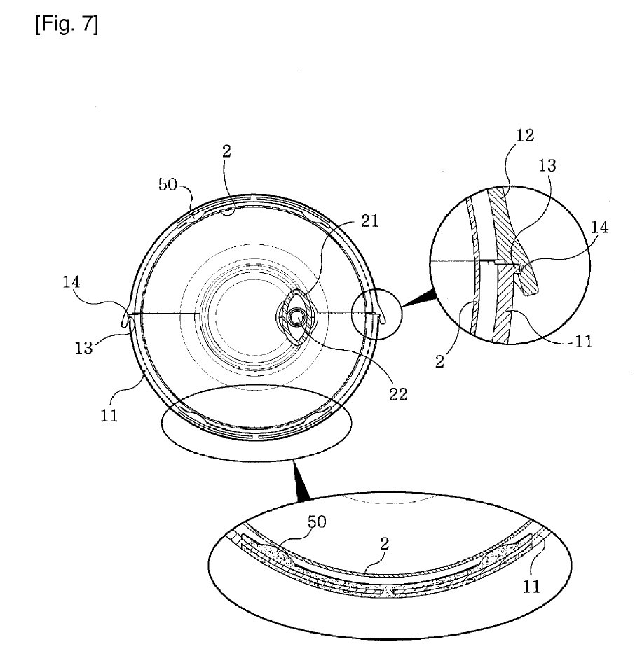

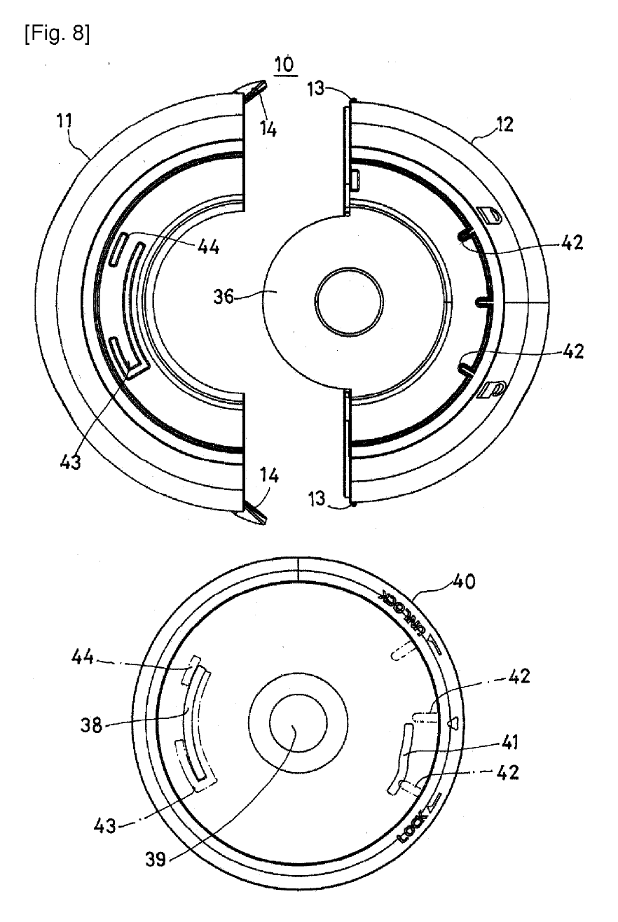

FIG. 7 is a cross-sectional view showing the coupled state of the glass vessel and the protective cover of the baby bottle, according to the present invention. The protective cover 10 covers the glass vessel 2 of the baby bottle 1 to thus protect it. The shock absorbing members 50, which are provided on the upper and lower portions of the left and right cover bodies 11 and 12 of the protective cover 10, correspond to the outer surface of the glass vessel 2. Thereby, external shocks are primarily absorbed by the protective cover 10, and are secondarily absorbed by the shock absorbing members 50, so that the shocks are completely absorbed, thus protecting the glass vessel 2.

FIG. 8 is a view illustrating the lower surfaces of the left and right cover bodies and the upper surface of the base unit, according to the present invention. The fitting groove 43 is provided on the lower surface of the left cover body 11, constituting the protective cover. Further, the support piece 44 is provided at a predetermined position around the fitting groove to be spaced apart there from by a predetermined interval, and supports one end of the fitting protrusion, thus preventing the left cover body from being opened.

The one-dot chain lines of FIG. 8, which are drawn on the upper surface of the lower base plate, show the fitting groove and the locking projections, which are provided on the bottoms of the left and right cover bodies 11 and 12 of the protective cover 10. FIG. 8 shows the coupled state of the fitting protrusion and the fitting groove, and the coupled state of the elastic piece and the locking projections.

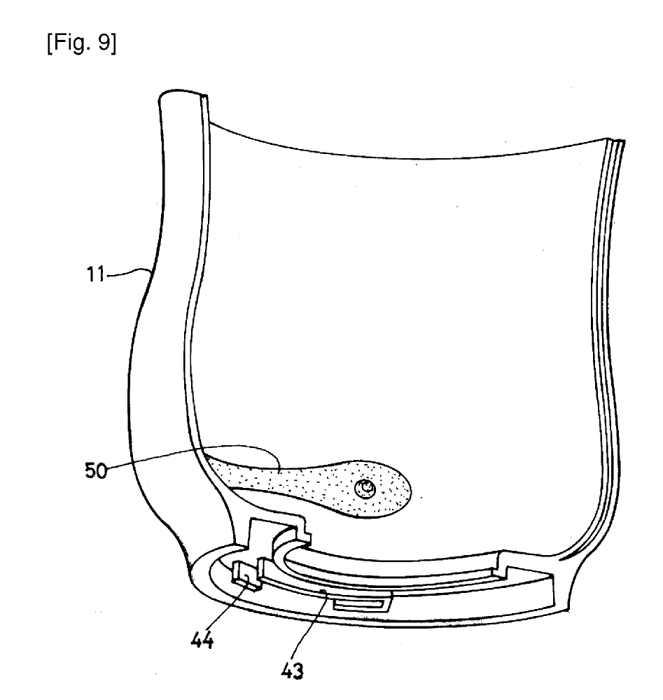

FIG. 9 shows the construction of the lower portion of the left cover body 11 constituting the protective cover 10, according to the present invention. The drawing shows the fitting groove, the support piece, and the lower portion of the left cover body.

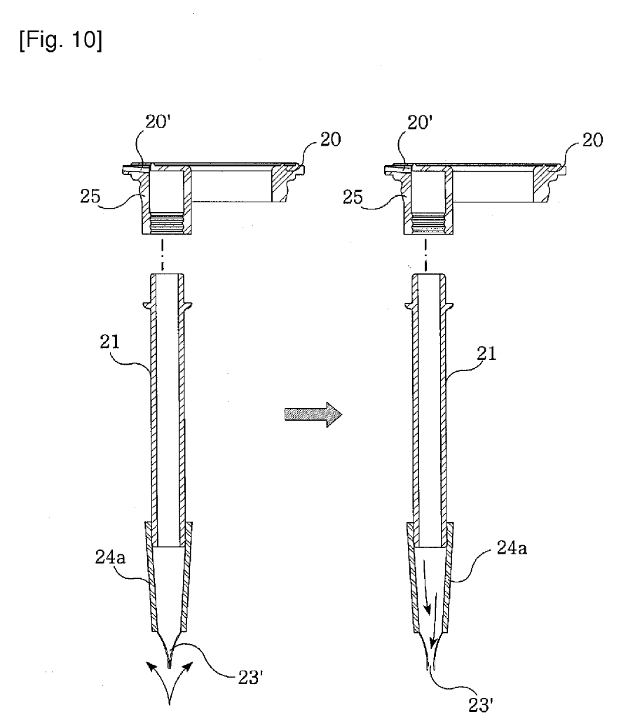

FIG. 10 is a view showing another embodiment of the present invention, in which the closed and opened states of an air ventilation tube are shown. This drawing shows another embodiment of an air valve 24a which is provided on the lower end of the ventilation tube 21. According to this embodiment, a ball is not inserted into the air valve 24a, and the air valve 24a is funned such that its upper portion is wide and its lower portion is narrow, and an air inlet port 23′ is formed in one end of the air valve. In this case, the air valve has a flat shape.

When a baby sucks the nipple to ingest milk, pressure is generated in a direction from the bottom of the glass vessel to the nipple, so that the air inlet port 23′ of the air valve 24a provided on the ventilation tube 21 is opened, and thus air is discharged. Meanwhile, when the baby does not suck, so that pressure does not act on the milk, the end of the air valve 24a is closed, and thus the inflow of air is prevented.

A conventional glass vessel is formed to have a thickness of 3 to 3.3 mm in order to prevent breakage of the glass vessel. However, according to the present invention, the protective cover is used, so that the glass vessel 2 has a thickness of 1.7 to 1.8 mm. As such, the present invention realizes a light glass baby bottle, thus affording convenient and easy handling.

Further, the shock absorbing members 50 are provided on the upper and lower portions of the left and right cover bodies 11 and 12 of the protective cover 10, so that 8 protruding parts contact the outer surface of the glass vessel, thus supporting four points of the upper portion of the glass vessel and four points of the lower portion of the glass vessel. The remaining portion of the glass vessel is spaced apart from the protective cover, thus defining a space, therefore mitigating the shocks that are applied to the baby bottle when it is dropped.

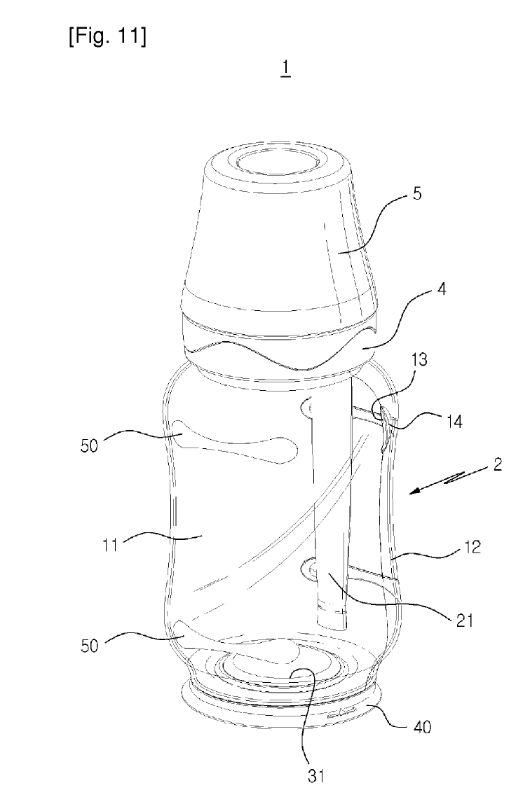

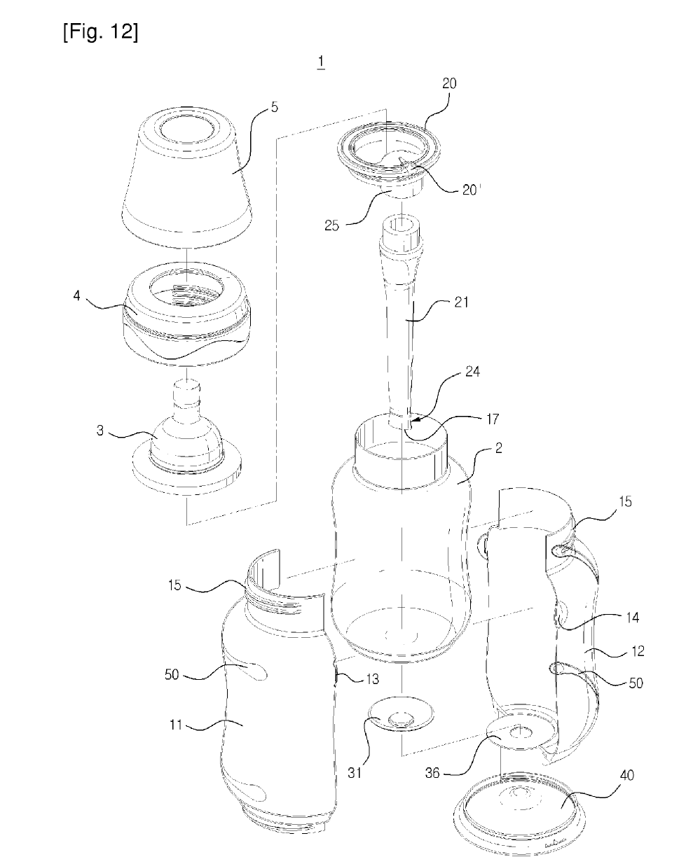

FIGS. 11 and 12 are a perspective view and an exploded perspective view, respectively, showing a baby bottle, according to another embodiment of the present invention. According to the present invention, the baby bottle 1 is provided with the air valve 24 on an end of the ventilation tube 21 which is connected to the air inlet packing 20. The air valve 24 has an elliptical reinforcing rib, thus preventing the air outlet port from being opened due to the motion of water when powdered milk is mixed with the water, therefore maintaining the original shape of the valve.

Further, the ventilation tube 21 is made of one of silicone, soft synthetic resin, and soft rubber, which are treated to prevent endocrine disruptors, and helps realize smooth stirring to mix powdered milk and water in the glass vessel.

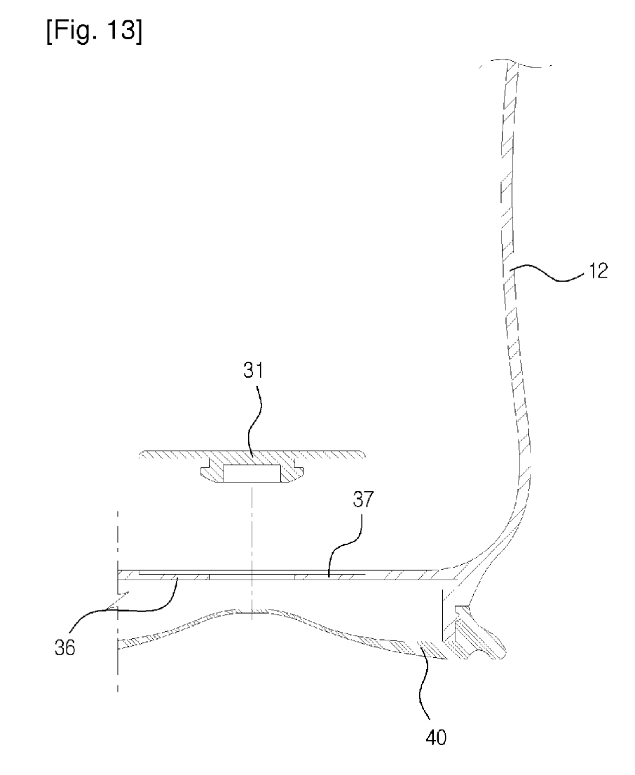

FIG. 13 is a view showing the construction of the lower portion of a protective cover, according to a further embodiment of the present invention. When the coupling protrusion 35, provided on the lower surface of the cushioning plate 31, is inserted into the hole 39 in the middle base plate 36 which is provided on the lower end of the right cover body and has the shape of a “J”, the cushioning plate 31 is attached to the upper surface of the middle base plate 36.

Further, the lower base plate 40 is in close contact with the outer edges of the lower ends of the left and right cover bodies 11 and 12 and is fastened to the protective cover 10.

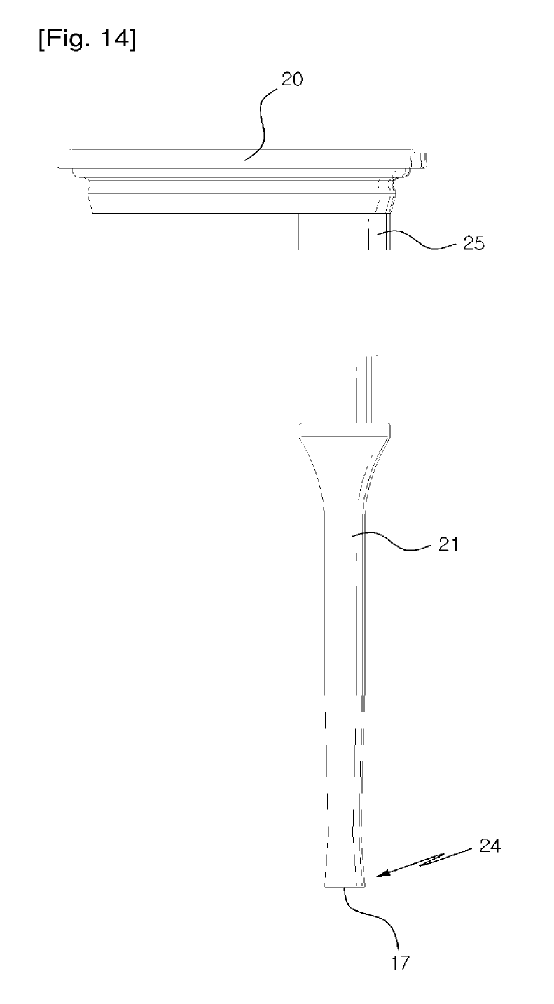

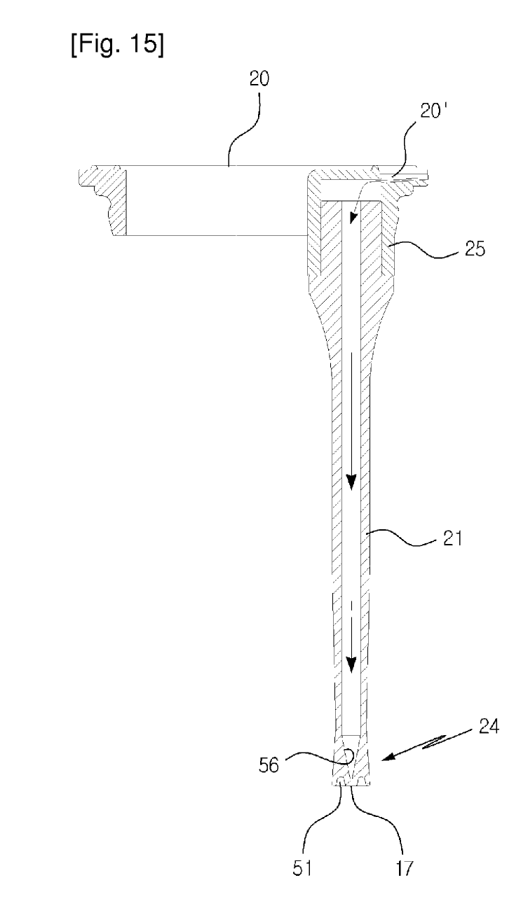

FIGS. 14 and 15 are a perspective view and a sectional view, respectively, showing a ventilation tube, according to another embodiment of the present invention. The coupling tube 25 protrudes downwards from a predetermined position on the bottom of the air inlet packing 20, and is coupled to the upper end of the ventilation tube 21. The coupling tube 25 provided on the air inlet packing 20 communicates with an air inlet hole 20′, which is formed at a predetermined position in the upper surface of the air inlet packing, so that air is fed through the ventilation tube 21 into the glass vessel 2.

Even if the air inlet packing 20 is fastened using the support cap 4, air is fed through threaded parts, which are provided at the junctions of the support cap 4 and the fastening parts 15 of the protective cover 10, into the air inlet hole 20′ formed in the air inlet packing 20, prior to flowing through the ventilation tube 21 into the glass vessel.

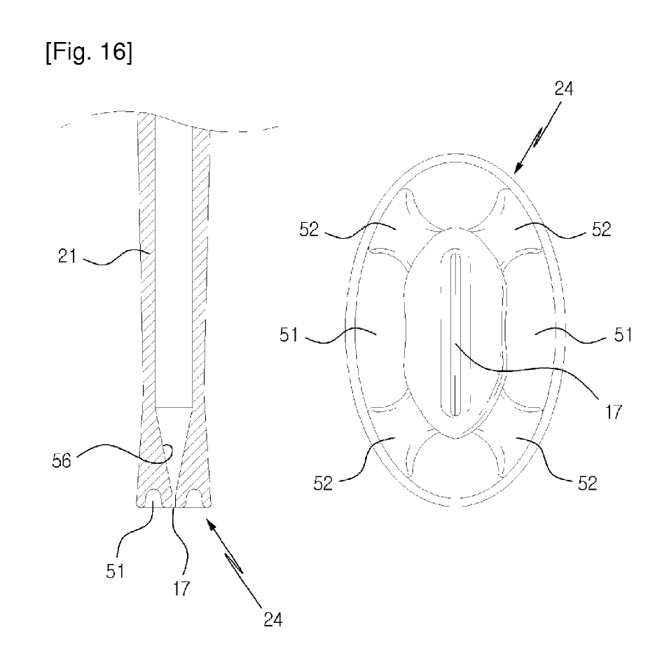

FIG. 16 is a sectional views showing important parts of a ventilation tube, according to a further embodiment of the present invention. An air valve 24 is mounted to one end of the ventilation tube 21, which is made of a soft elastic material, such that external air can enter the ventilation tube but milk cannot flow through the end of the ventilation tube into the ventilation tube.

Here, the air valve 24 provided on the ventilation tube 21 has an air outlet port 13 which has an elliptical shape and has in a center thereof a “-”-shaped gap. A plurality of reinforcing ribs 52 and grooves 51 is provided around the air outlet port 17, thus performing a valve function.

That is, the air outlet port 17 is seen as a “-”-shaped line from the exterior, and the “V”-shaped inclined surface 56, which is narrow at the lower end thereof and widens in a direction from the lower end to the upper end, is formed in the air outlet port. This structure allows internal air to be discharged to the end of the ventilation tube 21, but prevents milk from flowing through the air outlet port 17 into the ventilation tube 21.

The reinforcing ribs 52, which are provided on the air valve 24, prevent the “-”-shaped air outlet port 17 from being opened by external pressure. Since the grooves are formed inwards, the air outlet port is further closed if milk enters the grooves.

Further, the “V”-shaped inclined surface is provided in the air valve, so that the air valve is opened by suction force when a baby ingests milk, and thus the inflow of air is allowable. Therefore, the ventilation tube 21 is not clogged with milk during feeding, thus preventing air from flowing backwards.

In particular, the ventilation tube 21 has on one end thereof the elliptical reinforcing ribs 52, thus preventing the air outlet port 17 from being, opened due to the motion of water when powdered milk is mixed with water, and maintaining the original shape of the valve.

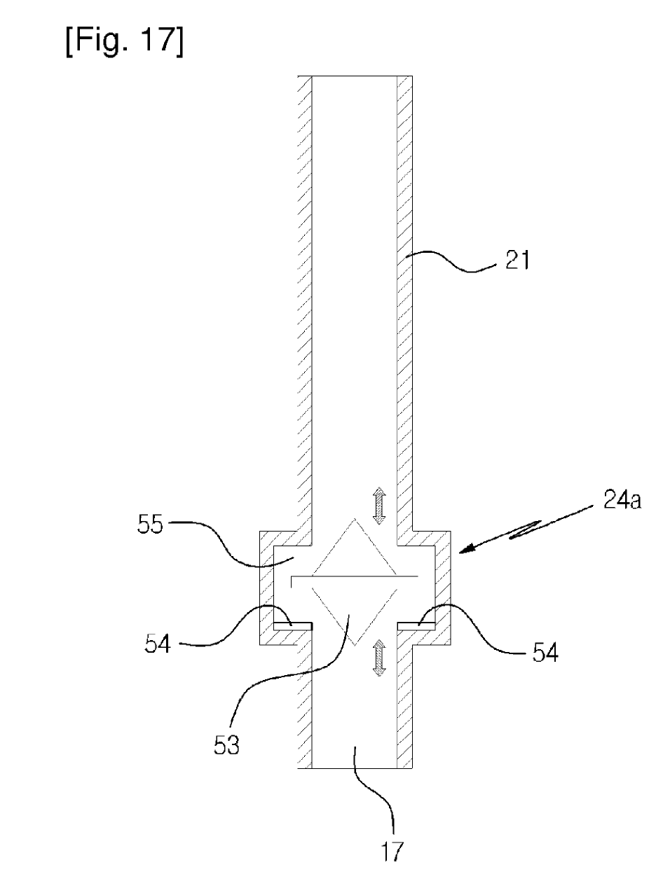

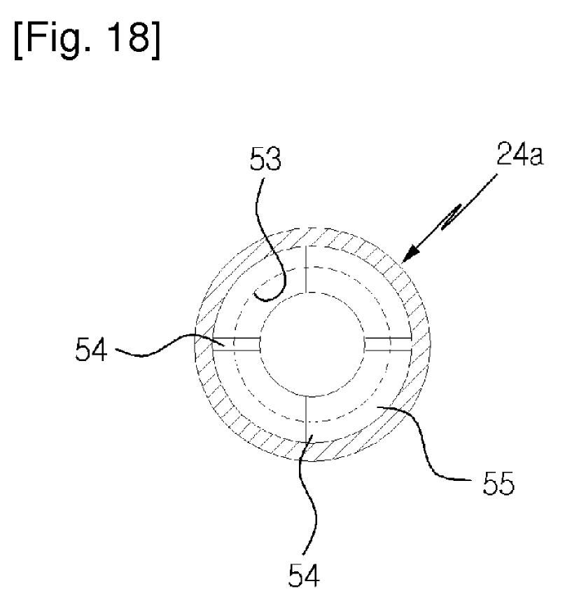

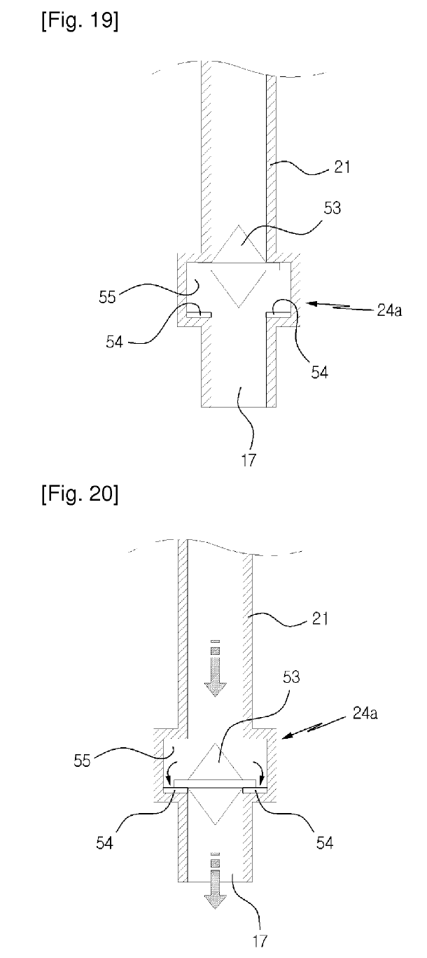

FIGS. 17 and 18 are a sectional view and a plan view, respectively, showing a ventilation tube according to another embodiment of the present invention, and FIGS. 19 and 20 are views illustrating the operation of the ventilation tube of FIG. 18. A valve chamber 55 is defined in the lower end of the cylindrical ventilation tube 21, and has a larger diameter than the ventilation tube, with a valve control member 53 installed in the ventilation tube.

When the valve control member 53 installed in the valve chamber 55 is immersed in milk contained in the glass vessel 2, the valve control member 53 is pushed upwards by milk, like a buoy, and closes the upper end of the valve chamber 55, thus preventing the milk from flowing into the ventilation tube 21.

Further, when a baby sucks the nipple to ingest milk, the valve control member 53 is moved to the lower end in the valve chamber 55 by the suction force of the baby. Since a plurality of air inlet holes 54 is formed in the lower end of the valve chamber 55, external air flows into the ventilation tube, and thereafter, flows through the air inlet holes to the bottom of the glass vessel. This construction allows a baby to comfortably ingest milk.

As shown in FIG. 19, even if the glass vessel 2 is filled with milk, the valve control member 53 positioned in the valve chamber 55 closes the upper end of the valve chamber 55, so that milk is not fed into the ventilation tube any longer.

Further, as shown in FIG. 20, even if the valve control member 53 closes the lower end of the valve chamber 55, the circumferential length of the air inlet holes 54 is greater than that of the valve control member 53, so that air is fed through the air inlet holes 54, which are positioned outside the valve control unit 53, into the glass vessel during feeding, and pushes milk in the glass vessel, thus allowing, the baby to conveniently ingest the milk.

As such, according to the present invention, the air outlet port 17, which serves as the valve, so as to prevent the inflow of milk, is provided on one end of the ventilation tube 21 positioned in the baby bottle, thus preventing air from flowing, backwards during feeding, therefore preventing a baby from ingesting both air and milk together. The ventilation tube 21 is made of an elastic material to have an integrated structure, and enables stirring to mix powdered milk and water in the baby bottle with each other. Further, an elliptical reinforcing rib is provided on the end of the ventilation tube, thus preventing the air outlet port from being opened due to the fluctuation of water when the powdered milk and the water are mixed with each other, and maintaining the original shape of the valve.

The operation of the baby bottle according to the present invention, which is constructed as described above, will be described below.

As shown in FIGS. 1 to 20, when a user wishes to assemble the baby bottle 1 of the present invention, first, the connection plate 33 is coupled to the upper surface of the middle base plate 36, which is provided on the lower end of the right cover body 12 of the protective cover 10 and constitutes the base unit.

At this time, the cushioning plate 31 is connected to the connection plate 33 such that the connecting projections 32 of the cushioning plate are fitted into the connecting holes 34 in the connection plate 33. Subsequently, the coupling protrusion 35 of the connection plate 33 is inserted into the coupling hole 37 in the middle base plate 36.

Next, the glass vessel 2 is placed on the upper surface of the middle base plate 36, and the left and right cover bodies 12 and 11 are coupled to each other to protect the glass vessel. When the left and right cover bodies 11 and 12 of the protective cover 10 are coupled to each other, the fastening protrusions 13 of the left cover body 11 are fitted into the fastening holes 14 in the right cover body 12.

Further, the fitting protrusion 38 of the lower base plate 40 is fitted into the fitting groove 42, which is provided on the bottom of the left cover body 11.

After the fitting protrusion 38 of the lower base plate 40 is fitted into the fitting groove 43 of the left cover body 11, one end of the fitting, protrusion is supported by the support piece 44 so as to prevent the removal of the fitting protrusion.

Further, the elastic piece 41 of the lower base plate 40 is locked to the corresponding locking projection 42, so that the base unit 30 is coupled to the protective cover 10.

According to the present invention, the characters, “LOCK/UNLOCK” are displayed on the outer surface of the lower base plate 40 so as to indicate the locked or unlocked state. When the lower base plate 40 is coupled to the lower surface of the protective cover 10 and is turned to one side, a user can easily distinguish the locked state from the unlocked state.

Thus, when the lower base plate 40 is aligned with the lower surface of the protective cover 10 and is then turned to the locked state, the fitting protrusion 38 of the lower base plate 40 is fitted into the fitting groove 43 provided in the lower surface of the left COWS body 11. Simultaneously, an associated locking projection 42, provided on the lower surface of the right cover body 12, is locked to a groove which is formed in the elastic piece 41 of the lower base plate 40.

At this time, the elastic piece 41 is elastically supported by the lower base plate. Thus, when the associated locking projection 42 comes into contact with the elastic piece, sound is generated, thus allowing a user to easily be aware of the locked or unlocked state.

As such, the protective cover 10 is coupled to the outer surface of the glass vessel 2, and the base unit 30 is secured to the lower surface of the protective cover 10. Thereafter, the ventilation tube 21 having the air valve 24 is coupled to the air inlet packing 20, which is seated on the upper end of the glass vessel, and the ventilation tube 21 is installed to be positioned in the glass vessel using the coupling tube 25, which is integrally provided on the lower surface of the air inlet packing 20.

After the air inlet packing 20 is seated on the upper end of the glass vessel, the support cap 4 equipped with the nipple 3 is fastened to the fastening parts 15 of the protective cover 10, so that the assembly of the baby bottle 1 is completed.

In the baby bottle 1 assembled in this way, the outer surface of the glass vessel 2 is spaced apart from the inner surface of the protective cover 10 by the shock absorbing members 50, which are provided on the upper and lower portions of both sides of the protective cover in such a way as to protrude inwards, thus mitigating external shocks transmitted to the glass vessel, therefore preventing the glass vessel from breaking.

By covering the support cap 4 with a general lid 5, the nipple 3 can be kept clean.

Further, the air valve 24, which is provided on the end of the ventilation tube 21, is constructed so that external air is fed into the glass vessel and milk in the glass vessel 2 is not fed into the air outlet port 17, thus sucking milk with a predetermined pressure, and preventing air from being ingested together with milk, therefore preventing a baby from suffering from colic or inflammation of the middle ear. Further, the present invention prevents the application of excessive force to the mouth, thus preventing the shape of the mouth from being deformed due, to the habit of sucking the nipple.

1. A baby bottle, comprising:
a glass vessel containing milk therein;
a protective cover having on an inner surface thereof a shock absorbing member to protect the glass vessel, and comprising left and right cover bodies which are provided with one selected from among a fastening protrusion and a fastening hole and a remaining one thereof, respectively;
an air inlet packing placed on an upper end of the glass vessel, with a ventilation tube coupled to the air inlet packing to permit inflow of external air during feeding; and
a support cap fastened to an upper end of the protective cover in such a way that a nipple is in close contact with an upper portion of the air inlet packing, when the air inlet packing is in close contact with the glass vessel.

2. The baby bottle according to claim 1, wherein the protective cover comprises on a lower end thereof a base unit to correspond to a lower surface of the glass vessel.

3. The baby bottle according to claim 2, wherein the base unit comprises:
a middle base plate provided on a lower end of either of the left and right cover bodies, and having a coupling hole;
a cushioning plate coupled to the middle base plate; and
a lower base plate coupled to a lower surface of the middle base plate.

4. The baby bottle according to claim 3, wherein the base unit comprises a connecting projection provided on a lower surface of the cushioning plate, and is supported by a connection plate, which is coupled via a coupling protrusion to the coupling hole and has on an upper surface thereof a connecting hole, the lower base plate being supported by the coupling protrusion, which protrudes from a lower surface of the connection plate.

5. The baby bottle according to claim 2, wherein the base unit comprises a hole which is formed in a center of the lower base plate such that the coupling protrusion is inserted into the hole, the lower base plate comprising at a predetermined position on an upper surface thereof a fitting protrusion, which is fitted into a fitting groove provided on a lower surface of the left cover body, and comprising at a predetermined position thereof an elastic piece to correspond to a plurality of locking projections which are provided on a lower surface of the right cover body.

6. The baby bottle according to claim 2, wherein the middle base plate and the cushioning plate of the base unit are coupled to each other by inserting a coupling protrusion, provided on the lower surface of the cushioning plate, into the coupling hole in the middle base plate, and the lower base plate is in close contact with outer edges of lower ends of the left and right cover bodies.

7. The baby bottle according to claim 1, wherein a lid is coupled to an outer portion of the nipple.

8. The baby bottle according to claim 1, wherein the air inlet packing comprises an air inlet channel so that air, supplied through a gap between the support cap and a fastening part of the protective cover, flows into the ventilation tube.

9. The baby bottle according to claim 1, wherein the ventilation tube is made of an elastic material, and comprises on a lower portion thereof an air valve which prevents discharge of milk but permits inflow of air.

10. The baby bottle according to claim 9, wherein the air valve comprises a plurality of reinforcing ribs and grooves which prevent milk from being fed through an air outlet port formed in an end of the air valve, an inner surface of the air outlet port comprising a “V”-shaped inclined surface which is narrow at a lower end thereof and is wide at an upper end thereof.

11. The baby bottle according to claim 9, wherein the air valve comprises a valve chamber, which is provided on a lower portion of the ventilation tube and has a diameter greater than that of the ventilation tube, with a valve control member provided in the valve chamber and a plurality of air inlet holes formed in a lower end of the valve chamber.

12. The baby bottle according to claim 9, wherein the air valve is mounted to a lower end of the ventilation tube in such a way that a ball is positioned in the air valve, with an air inlet port provided at a predetermined position in the air valve.

13. The baby bottle according to claim 12, wherein the air valve further comprises a backward-movement preventing protrusion so as to prevent the ball from blocking the ventilation tube.

14. The baby bottle according to claim 9, wherein the air valve comprises on a lower end thereof an air inlet port which is wide at an upper portion thereof and is narrow at a lower portion thereof.
